(19) United States
(12) Patent Application Publication
(10) Pub. No.: US 2026/0172299 A1
(43) Pub. Date: Jun. 18, 2026

(54) MULTI-CLOUD MESH

(71) Applicant: Cisco Technology, Inc., San Jose, CA (US)

(72) Inventors: William Mark Townsley, San Francisco, CA (US); Mark Alan Bakke, Maple Grove, MN (US); Mirko Graebel, Los Altos, CA (US)

(21) Appl. No.: 18/984,226

(22) Filed: Dec. 17, 2024

(51) Int. Cl. H04L 41/042; H04L 41/40; H04L 47/20

(52) U.S. Cl. CPC H04L 41/042; H04L 41/40; H04L 47/20

(57) ABSTRACT

Techniques for enabling streamlined and simplified management of connections across cloud service providers (CSPs). The techniques provide a new, decentralized, multi-tenanted multi-cloud mesh that utilizes cloud-specific integrations, such as cloud infrastructure templates (e.g., AWS cloud formation templates, Azure Resource Manager Templates, etc.) and virtual points of presence (vPoPs) to provide on-demand or dynamic generation and management of connections. The cloud infrastructure templates may automatically configure network elements in a cloud account of a user to enable the network elements to connect to the vPoPs within the multi-cloud mesh. The vPoPs are deployed within the multi-cloud mesh (e.g., within VPCs of different CSPs), are lightweight, multi-tenanted, and can be set up a new region in minutes. The technique provides automated discovery and configuration of connections between network elements and the multi-cloud mesh, across CSPs, and management of the connections on behalf of the user.

### TECHNICAL FIELD

The present invention relates generally to computer networking and more specifically to providing multi-cloud networking as a service via a network management system that operates across cloud service providers.

### BACKGROUND

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs, Enterprise Networks that are built for a large organization, Internet Service provider (ISP) Networks that operate WANs to provide connectivity to individual users or enterprises, software-defined networks (SDNs), wireless networks, core networks, cloud networks, and so forth.

An example network is a public cloud service provider (CSP). For instance, a customer (e.g., a tenant, such as a company or enterprise) environment can include a single CSP or multiple CPSs, such as AWS, Azure, Oracle, etc. The customer may use multiple CPS for a variety of reasons (e.g., specific features, mergers and acquisitions, dual-vendor policies, etc.). When using the CSPs, the customer may also still operate their private clouds and branches.

As an example, a customer may have workloads running in a single CSP (e.g., such as AWS). Additionally, the customer may have hundreds or even thousands of accounts or subscriptions associated with each of these workloads. For instance, a customer (e.g., such as a company) can have various teams (e.g., application teams, marketing teams, etc.). Each team can have multiple accounts within the CSP. Where the customer runs or has hundreds of teams, there can be thousands of accounts running in the single CSP, resulting in the customer needing infrastructure and IT support to run and maintain all of the accounts. Further, when the accounts of a customer are expanded across multiple cloud systems, various additional complexities and limitations are introduced that may differ between each cloud system.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an environment in which a system provides an example multi-cloud mesh that provides a simplified mechanism for managing multi-cloud connectivity between CSPs.

FIG. 2 illustrates a system-architecture diagram of an environment in which a system illustrates exemplary traffic pathways enabled by the system described in FIG. 1 herein.

FIG. 3A illustrates an example environment that supports deep integration according to the techniques described herein.

FIG. 3B illustrates an example environment that supports deep integration according to the techniques described herein.

FIG. 4A illustrates a flow diagram of an example system that performs on-demand generation and configuration of connections using cloud infrastructure templates and vPoPs, according to the techniques described in FIGS. 1-3B.

FIG. 4B illustrates a flow diagram of an example system that performs dynamic generation and configuration of connections using vPoPs, according to the techniques described in FIGS. 1-4A.

FIG. 5 illustrates a flow diagram of an example system for streamlining and simplifying management of connections across CSPs using on-demand generation and configuration of connections to the MCN, according to the systems and techniques described in FIGS. 1-4B.

FIG. 6 illustrates a flow diagram of an example system for streamlining and simplifying management of connections across CSPs based on dynamic generation and configuration of connections to the MCN, according to the systems and techniques described in FIGS. 1-5.

FIG. 7 is a computer architecture diagram showing an illustrative computer hardware architecture for implementing a device that can be utilized to implement aspects of the various technologies presented herein.

### DESCRIPTION OF EXAMPLE EMBODIMENTS

### OVERVIEW

The present disclosure relates generally to the field of computer networking and more specifically to providing multi-cloud networking as a service via a network management system that operates across cloud service providers. For instance, the techniques described herein may relate to providing a network management system (NMS) as a service of a multi-cloud network (MCN).

A method to perform the techniques described herein may include receiving, by the NMS, input to connect a cloud account of a user to the MCN. The method may include generating, by the NMS and based on the input, a cloud infrastructure template. The method may also include determining, by the NMS and based on the cloud infrastructure template being applied to the cloud account in a cloud network, network elements within the cloud network. The method may include determining, by the NMS, one or more network elements to connect to the MCN. The method may also include generating, by the NMS, one or more virtual points of presence (vPoPs) within the MCN configured to form connections to the one or more network elements. The method may include monitoring, by the NMS, the connections.

Additionally, any techniques described herein, may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### EXAMPLE EMBODIMENTS

As noted above, the use of multiple CSPs introduces various complexities for customers. Some complexities may relate to managing a customer network over multiple cloud networks. One such complexity relates to connecting different workloads and CSPs. As each cloud system has different components, connecting between cloud system(s) and the customer’s private clouds and branches is difficult. For instance, a customer may want to deploy an application in two separate CSPs (e.g., such as AWS and Azure). However, how the two CSPs are structured, perform tagging, name components, etc. can be very different. This is not only highly complex but requires specialty knowledge in networking for both CSPs to enable network elements from one CSP to connect to network elements from another CSP, resulting in a need to hire staff that specialize in each CSP. Accordingly, managing the customer network can be resource intensive, complex, and costly for the customer to track and maintain.

Another complexity arises when a portion of the customer accounts are received via an acquisition or when an application team starts up from scratch. In these instances, subnet address ranges (e.g., NATs) of the accounts can overlap or have other issues that need to be addressed before the accounts can access or connect to services within the customer’s network. This results in a company requiring additional specialized teams to manually correct the overlap, as well as identify and establish new connections between the customer accounts, applications, and CSPs. This is not only time-consuming and complex to sort out, but results in various accounts lacking connections to company resources and services.

Additionally, complexities can relate to inconsistencies between the different CSPs. For instance, each CSP may have inconsistencies in the capabilities between each CSP and the sites of the customer. Each CSP may have differences in the limitations of components between each CSP and networking elements of the customer. One such limitation may relate to how each CSP tags various cloud objects. These inconsistencies also increase the complexity of providing security and observability to the customer in an end-to-end integration between CSPs. For instance, providing connectivity between different firewalls and security features of different CSPs can be complex as permissions may differ or conflict and addresses between network elements may overlap. These inconsistencies also increase the complexity of providing security and observability to the customer in an end-to-end integration between CSPs. Thus, managing multiple CSPs for a company is difficult, costly, and resource intensive.

Moreover, complexities can relate to identifying when connections go down. For instance, some existing techniques may utilize an agent to test various connections. However, existing techniques that utilize agents currently are not configured to run in a multi-cloud network and require thousands of instances of the agent to be deployed within customer networks and the CSP, resulting in a large amount of resources being utilized. Further, each test run by an instance of an agent can result in a cost to the customer. Accordingly, running a test across thousands of instances of the agent can be expensive. Additionally, expenses can be high due to the tests needing to be manually configured for each of the agent instances, resulting in large amounts of time and resources being utilized by the customer. Moreover, the use of the agent may differ between CSPs, and may be internet focused, such that the agent will not run within the customer’s private network. Accordingly, a simplified way to test and provide observability of connections to the customer in an end-to-end integration between CSPs is needed.

Moreover, inconsistencies between CSPs can include tagging inconsistencies. For instance, each CSP has differences in what elements a customer can tag, what groups (or users) a customer can tag, what traffic a customer can tag, how to name the tags, how the tags are tracked across the CSP, etc. As an example, tags can be placed on a variety of network elements within a CSP, such as general resources, a VPC, an instance, a subnet, etc. The CSPs may each have a different way to tag instances or VPCs, but not all CSPs have a way to tag a subnet. Further, for each CSP, a customer can decide which of the customer networks to connect in different ways. As an example, the customer may use a user interface to indicate they want to connect VPC1 to VNET2. However, where there are large amounts of VPCs/VNET, such as in a customer network described above, this is difficult to track, especially where the VPCs or VNETs are dynamic (e.g., VPCs generated with terraform) and may come into and out of existence every day, every hour, etc. Accordingly, tracking tags across CSPs is difficult and a user is unable to define their own tags in a simple way that can be utilized in cross cloud platforms.

Moreover, under existing techniques, where a customer indicates that they want to connect VPC1 to VNET2, the techniques may establish connections between VPC1 and everything in a particular CSP, and subsequently filter out the non-identified connections using a firewall, etc. However, doing so is resource intensive and can introduce various security risks. Due to the resource requirements of propagating all routes to VPC1, existing techniques are difficult and costly to scale.

Accordingly, there is a need to provide a simplified way to create and manage multi-cloud connectivity between CSPs.

This disclosure describes techniques for providing a network management system (NMS) as service of a multi-cloud network (MCN). The techniques may relate to dynamically generating and configuring connections using cloud infrastructure templates and vPoPs. In some examples, the techniques include receiving, by the NMS, input to connect a cloud account of a user to the MCN. The techniques may include generating, by the NMS and based on the input, a cloud infrastructure template. The techniques may also include determining, by the NMS and based on the cloud infrastructure template being applied to the cloud account in a cloud network, network elements within the cloud network. The techniques may further include determining, by the NMS, one or more network elements to connect to the MCN. The techniques may include generating, by the NMS, one or more virtual points of presence (vPoPs) within the MCN configured to form connections to the one or more network elements. The techniques may include monitoring, by the NMS, the connections.

In some examples, the system provides the ability to have a single network management system (NMS) and a method of operation across the CSPs in a multi-cloud network (MCN), so that the customer can run workloads in their cloud of choice for various reasons (e.g., cost, capabilities, mergers/acquisitions, etc.). In some examples, the system may operate gateways in all of the availability zones of all of the CSPs, such that the system may provide MCN management as a service. For instance, the service may correspond to the NMS that includes a dashboard (e.g., such as a Meraki dashboard) and/or is implemented as an application (e.g., such as a SaaS app) that interfaces with a user device of the customer. In some examples, the system may utilize a gateway of a service provider (e.g., such as a Cisco native gateway) instead of a gateway associated with the CSP. The system may be configured to set up encrypted tunnels between all the different gateways in order to route the traffic over the internet and between CSPs.

In some examples, the system includes virtual points of presence (vPoPs). In some examples, the vPoPs comprise cloud native head end (CNHE) vPoPs and may represent an end point that the customer talks to and/or connects to. The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco), thereby providing the system with improved latency characteristics and enabling the system to leverage specific functionalities of each CSP. Thus, by utilizing vPoPs, the system may provide lightweight vPoPs that can be located anywhere (e.g., such as within a cloud) and can be set up of a in a new region within minutes. While the examples described herein relate to utilizing CNHEs, it is understood that any appropriate container may be used for the vPoPs.

Accordingly, the vPoPs deployed by the system are outside of the CSP regions that are owned by the customer (e.g., and instead are deployed in VPCs/VNETs of the service provider), such that the system is not deploying code, virtual machines, instances, etc. of the vPoPs to the customer network(s), thereby enabling the customer to implement the system without having to allocate additional network resources (e.g., CPU, memory, etc.) of network devices, or increasing costs to the customer. Moreover, by deploying the vPoPs within the MCN, the system is configured to handle software upgrades, security tickets, etc. on behalf of the customer, such that the customer does not need to see or handle updates or security tickets for thousands of accounts.

In some examples, the vPoPs are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

In some examples, the system may be configured to keep one or more of data traffic, routes, statistics, etc. of different tenants separate from each other. In some examples, the vPoPs may be configured to connect the tenancies (e.g., all of Tenant A together, All of Tenant B together, etc.). Each vPoP may be configured to transmit data to each other over the internet, or other cores (e.g., such as a 100 GB core). Accordingly, the system may be configured to provide a per customer topology between the vPoPs that is automated, provides flexibility in the types of tunnels, use of single or multiple tunnels, and/or providing balancing across the tunnels when needed (e.g., such as to get around administration limitations).

In some examples, the system may provide dynamic creation and management of vPoPs and connections between the customer network(s) and the MCN. In some examples, the system may utilize the cloud infrastructure template. In this example, the cloud infrastructure template is generated in response to a customer (or application programming interface (API)) request to connect an account of the customer to the MCN. The cloud infrastructure template may be configured to enable the system to go into a customer’s network and discover all of the VPCs/VNETs in the customer network(s), show them in the dashboard, and enable the customer to select which ones they want to connect. For instance, the cloud infrastructure template may add an identity and access management (IAM) role to each account being connected to the MCN. The system may automatically set up the connections between the VPCs/VNETs by configuring site-to-site VPN connections, virtual gateways, customer gateways, etc., and hooking them back to the multi-cloud mesh (e.g., by connecting them to vPoPs). In some examples, the system may set up traffic between the VPC and a vPoP, where the system optimizes the connection (e.g., based on priority of traffic, cost, quality of service (QoS), etc.) for the customer. The system may also set up the routing tables within the customer network and the multi-cloud mesh. Accordingly, the system may automatically discover and create connections between the customer network and the MCN without the customer having to assign addresses, configure connections, utilize specialized networking teams, etc. Moreover, the system may automatically create connections even where there are address overlap problems noted above. In this example, the system automatically corrects and updates the addresses and creates the connections with the MCN on behalf of the customer. Thus, the system can identify and correct overlap in the case of an acquisition and create connections between the customer accounts and the MCN, such that overlap does not occur in the future, thereby preventing delays in connections, streamlining correction of overlap issues, and simplifying the creation, set up, and management of connections in the MCN. Thus, the system itself can manage these connections on behalf of the customer.

In some examples, the system may enable the customer to manipulate or update the IAM role and change how much access and/or how many permissions the system has when accessing the customer network. For instance, the customer may update the IAM role to be semi-static (e.g., reduce the permissions granted to the system), such that the system may perform discovery of the VPCs/VNETs but is not allowed to configure the gateways or set up the connections within the customer network. In this example, the system may generate and provide instructions to the customer, such that the customer can set up the gateways and connections within the customer networks, in order to connect to the MCN.

In another example, the customer may update the IAM role to be static (e.g., on-demand, such that the MCN is granted no permissions) when generating vPoPs. In this example, the system may generate cloud infrastructure templates and provide them to the customer or API, such that the customer has complete control when applying the cloud infrastructure templates to their network. In this example, when changes to the connections are made and/or when VPCs or VNETs are added, new cloud infrastructure templates may need to be generated and applied to the customer network. Accordingly, the system may provide variable trust and control to customers that utilize the MCN as a service on a per account basis.

In some examples, the system may be configured to determine application(s) or network element(s) within the customer network(s) that need to connect. For instance, the system may utilize an observer component and/or one or more machine learning or artificial intelligence models to identify application(s) and/or network element(s) to connect within the MCN for the customer. Accordingly, the system may be configured to connect anything to anything within the CSP or at another CSP with the firewalls, access control lists (ACLs), with the ability to perform network address translation (NAT) and doctor up other IP addresses so they don’t conflict, etc.

In this way, the system may provide a simplified way to manage multi-cloud connectivity between CSPs (Azure, AWS, Oracle, etc.). Thus, the system creates a new, decentralized, multi-tenanted multi-cloud mesh that utilizes cloud-specific integrations, such as cloud infrastructure templates (e.g., AWS cloud formation templates, Azure Resource Manager Templates, etc.) and virtual points of presence (vPoPs) to provide on-demand or dynamic generation and management of connections. For instance, the system creates a new, decentralized architecture that utilizes vPoPs that are deployed within VPCs or VNETs of different CSPs, which provides the system with improved latency characteristics and enables the system to leverage specific functionalities of each CSP when forming connections, routing traffic, etc., resulting in optimized traffic flow and reduced costs to the customer. By utilizing vPoPs that are lightweight and can be located anywhere, the system provides a way to form a new connection by setting up a new vPop in a new region within minutes, reducing latency for the customer and streamlining connection management. Further, by including lightweight security built into the vPoPs (e.g., such as ACLs, stateless actions (e.g., NAT, etc.)), while handing off heavier features (e.g., such as deep packet inspection, firewalls, etc.), the system can provide secure connections that leverage functionalities within each CSP, while reducing the amount of network resources used.

Accordingly, the system may automatically generate connections between a customer network and the MCN, thereby reducing complexity, infrastructure, and cost to the customer. Moreover, the system automatically handles routing (optimized for the customer based on various factors), firewalling, etc. without the customer needing to provide input (e.g., without the customer even providing an IP address), thereby streamlining connection management and reducing the number of communications between the system and the customer or API, thereby improving bandwidth and freeing up other network resources available within the MCN.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

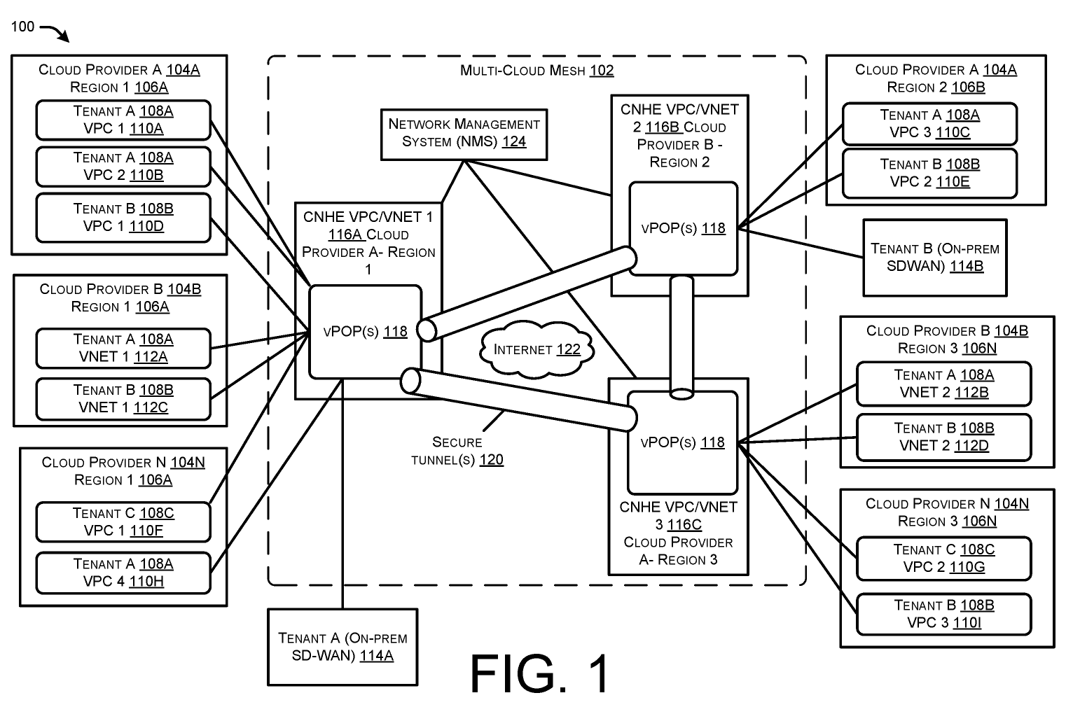

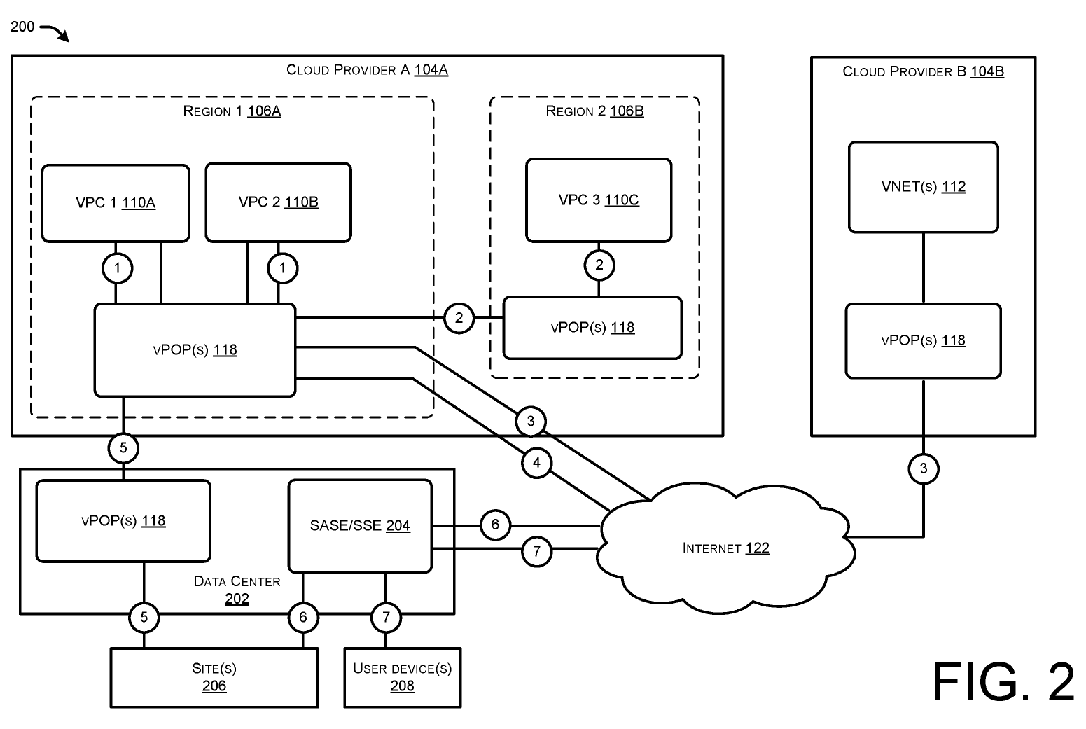

FIG. 1 illustrates a system-architecture diagram of an environment in which a system 100 provides an example multi-cloud mesh that provides a simplified mechanism for managing multi-cloud connectivity between CSPs. While the system 100 shows an example multi-cloud mesh, it is understood that any of the components of the system may be implemented on any device, network, and/or any cloud-based service provider. Moreover, while the system 100 does not illustrate a network management system, it is understood that any of the components illustrated in FIGS. 2-7 may be implemented and/or incorporated in the multi-cloud mesh.

In some examples, the system 100 may include multi-cloud mesh 102. As used herein, multi-cloud mesh 102 may be referenced as the “MCN” and vice versa. The multi-cloud mesh 102 may include one or more networks implemented by any viable communication technology, such as wired and/or wireless modalities and/or technologies. The multi-cloud mesh 102 may include any combination of Personal Area Networks (PANs), SDCI, Local Area Networks (LANs), Campus Area Networks (CANs), Metropolitan Area Networks (MANs), extranets, intranets, the Internet, short-range wireless communication networks (e.g., ZigBee, Bluetooth, etc.), Wide Area Networks (WANs)-both centralized and/or distributed, SD-WANs, SDNs-and/or any combination, permutation, and/or aggregation thereof. The multi-cloud mesh 102 may include devices, virtual resources, or other nodes that relay packets from one network segment to another by nodes in the computer network. The multi-cloud mesh 102 may include multiple devices that utilize the network layer (and/or session layer, transport layer, etc.) in the OSI model for packet forwarding, and/or other layers. In some examples, the multi-cloud mesh 102 correspond to an SD-WAN overlay.

The system 100 may comprise cloud provider(s) (e.g., cloud provider A 104A, cloud provider B 104B, cloud provider N 104N), which may correspond to various CSPs. For instance, cloud provider A 104A may represent AWS, cloud provider B 104B may represent Azure, and cloud provider N 104N may represent GPC.

Each cloud provider may have one or more site(s) associated with a particular region (e.g., region 1 106A, region 2 106B, region 3 106N, etc.). For instance, region 1 106A may represent a western portion of a particular geographic location (e.g., country, state, city, or any other suitable geographic location), region 2may represent a central portion of the geographic location, and region 3 106N may represent an eastern portion of the geographic location.

The site(s) may comprise data centers, which may be physical facilities or buildings located across geographic areas that are designated to store networked devices that are part of a manufacturer. The data centers may include various network devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples, the devices in the packet-forwarding networks may not be located in explicitly defined data centers but may be located in other locations or buildings. In some examples, the site(s) comprise network device(s), which may correspond to any computing device, routers, switches, computers, or any other type of network device. Edge device(s) may comprise routers, switches, access points, stations, radios, and/or any other network device.

Each cloud provider may be multi-tenanted. For instance, cloud provider A 104A in region 1 106A may provide services to Tenant A 108A and Tenant B 108B. Each tenant may correspond to a different customer (e.g., such as an enterprise, organization, private entity, etc.). As illustrated, tenant A 108A may utilize services provided by cloud provider A 104A, cloud provider B 104B, and cloud provider N 104N. For instance, the services may include virtual private clouds (VPC(s) 110) or virtual networks (VNET(s) 112) that each respective tenant pays the cloud service provider for. As illustrated, the services provided by each cloud provider to each respective tenant is located outside of the multi-cloud mesh 102.

As illustrated in FIG. 1, cloud provider A 104A may run various VPCs for each tenant in each region. For instance, for tenant A 108A, cloud provider A 104A may run VPC 1 110A and VPC 2 110B in region 1 106A and VPC 3 110C in region 2 106B. For tenant B, cloud provider A 104A may also run VPC 1 110D in region 1 106A and VPC 2 110E in region 2. Similarly, cloud provider B 104B may be configured to provide VNET services to tenants. As illustrated for tenant A 108A, cloud provider B 104B may run VNET 1 112A in region 1 106A and VNET 2 112B in region 3 106N. For tenant B, cloud provider B 104B may run VNET 1 112C in region 1 106A and VNET 2 112D in region 3 106N. Cloud provider N may also be configured to provide VPC services. For instance, for tenant C 108C, cloud provider N 104N may provide VPC 1 110F in region 1 106A and VPC 2 110G in region 3. For tenant A, cloud provider N 104N may provide VPC 4 110H in region 1. For tenant B, cloud provider N may provide VPC 3 110I in region 3.

Additionally, each tenant may have one or more physical location(s). For instance, Tenant A 108A may have an on-premises SD-WAN 114A. In some examples, the tenant A on-premises SD-WAN 114A may comprise a site or physical data center of tenant A. In some examples, the tenant A on-premises SD-WAN 114A may utilize features or protocols to connect to the multi-cloud mesh 102, such as Meraki and/or AutoVPN. Tenant B 108B may have an on-premises SD-WAN 114B. In some examples, the tenant B on-premises SD-WAN 114B may comprise a site or physical data center of tenant B and may be located in region 2. In some examples, the tenant B on-premises SD-WAN 114B may utilize features or protocols to connect to the multi-cloud mesh 102, such as Cisco’s Catalyst IPsec and/or ISR.

The multi-cloud mesh 102 may comprise network management system (NMS) 124. The NMS 124 may correspond to a system that has complete visibility into the fabric of a given network. In some examples, the NMS 124 may comprise one or more controllers, one or more processors, memory, one or more APIs, one or more applications, one or more components, etc. In some examples, and as described in greater detail below, the NMS 124 may be configured to generate cloud infrastructure templates and vPoP(s) 118. As illustrated in FIG. 1, the NMS 124 may be connected to one or more CNHE VPC/VNET(s) that comprise vPoP(s) 118, such that the NMS 124 can monitor, manage, and update each vPoP. While the examples described herein relate to utilizing CNHEs, it is understood that any appropriate container may be used for the vPoPs. Accordingly, the VPC/VNET(s) within the multi-cloud mesh 102 described herein are not limited to CNHE implementations.

The CNHE VPC/VNET(s) may correspond to a VPC or a VNET that is owned and/or managed by a service provider of the NMS (e.g., such as Cisco). As illustrated in FIG. 1, each CNHE VPC/VNET may be deployed within a particular cloud service provider and/or region. For instance, CNHE VPC/VNET 1 116A may run in cloud provider A region 1, CNHE VPC/VNET 2 116B may run in cloud provider B region 2, and CNHE VPC/VNET 3 116C may run in cloud provider A region 3. Accordingly, where cloud provider A represents AWS, CNHE VPC/VNET 1 116A and CNHE VPC/VNET 3 116C may represent instances of VPCs running in AWS. Where cloud provider B represents Azure, CNHE VPC/VNET 2 116B may represent instances of a VNET running in Azure. While the CNHE VPC/VNET(s) are illustrated as being run in different cloud providers, it is understood that a single CSP may be used or additional CSPs may be used.

As illustrated in FIG. 1, the vPoP(s) 118 in CNHE VPC/VNET 1 116A is configured to connect to each VPC and VNET running in cloud provider A 104A, cloud provider B 104B, and cloud provider N 104N in region 1 106A. Additionally, the vPoP(s) 118 in CNHE VPC/VNET 1 116A may be configured to connect to Tenant A on-premises SD-WAN 114A using various protocols. The vPoP(s) 118 in CNHE VPC/VNET 2 116B is configured to connect to each VPC and VNET running in each cloud provider in region 2 106B. Additionally, the vPoP(s) 118 in CNHE VPC/VNET 2 116B may be configured to connect to Tenant B on-premises SD-WAN 114B using various protocols. The vPoP(s) 118 in CNHE VPC/VNET 3 116C is configured to connect to each VPC and VNET running in each cloud provider in region 2 106B. Additionally, the vPoP(s) 118 in CNHE VPC/VNET 2 116B may be configured to connect to Tenant B on-premises SD-WAN 114B using various protocols.

As illustrated, the vPoP(s) 118 are connected using secure tunnel(s) 120, which may represent encrypted data tunnels or tunnels created using any secure tunneling protocol. In some examples, the secure tunnel(s) 120 may be associated with a connection determined by a tenant, such that traffic from different tenants may be routed according to different protocols. Further, as illustrated, the vPoP(s) may be configured to communicate over the internet 122 or any other suitable network connection (e.g., core(s), 100 GB core, etc.).

In some examples, the vPoP(s) 118 comprise cloud native head end (CNHE) vPoPs and may represent an end point that the customer talks to and/or connects to. The vPoPs are multi-tenanted, such that multiple customers may connect to a single vPoP. In some examples, the vPoPs are deployed within the MCN (e.g., a mesh interconnect), such as within a CNHE virtual private cloud (VPC) or a CNHE virtual network (VNET). For instance, the vPoPs may be deployed within regions of Azure, AWS, Oracle, etc. that are owned by a service provider (e.g., such as Cisco), thereby providing the system with improved latency characteristics and enabling the system to leverage specific functionalities of each CSP. Thus, by utilizing vPoPs, the system may provide lightweight vPoPs that can be located anywhere (e.g., such as within a cloud) and can be set up in a new region within minutes.

Accordingly, the vPoPs deployed by the system are outside of the CSP regions that are owned by the customer (e.g., and instead are deployed in VPCs/VNETs of the service provider), such that the system is not deploying code, virtual machines, instances, etc. of the vPoPs to the customer network(s), thereby enabling the customer to implement the system without having to allocate additional network resources (e.g., CPU, memory, etc.) of network devices, or increasing costs to the customer. Moreover, by deploying the vPoPs within the multi-cloud mesh 102, the NMS 124 is configured to handle software upgrades, security tickets, etc. on behalf of the customer, such that the customer does not need to see or handle updates or security tickets for thousands of accounts.

In some examples, the vPoP(s) 118 are configured to provide connections between one or more of Amazon Web Service (AWS) VPCs, Azure VNETs, Google Cloud Platform (GCP) VPCs, Meraki AutoVPN sites, Catalyst IPsec SD-WAN sites, or any other virtual, cloud, or on-premise connection.

In some examples, the vPoP(s) 118 and/or NMS 124 may be configured to keep one or more of data traffic, routes, statistics, etc. of different tenants separate from each other. In some examples, the vPoP(s) 118 may be configured to connect the tenancies (e.g., all of Tenant A together, All of Tenant B together, etc.). Each vPoP may be configured to transmit data to each other over the internet 122, or other cores (e.g., such as a 100 GB core). Accordingly, the system may be configured to provide a per-customer topology between the vPoPs that is automated, provides flexibility in the types of tunnels, improved throughput, flexibility in the number of tunnels used (e.g., single or multiple tunnels), and/or provides balancing across the tunnels when needed (e.g., such as to get around administration limitations).

Thus, the multi-cloud mesh 102 may be configured to provide a connectivity first architecture (versus a security first architecture that runs everything through a firewall). As used herein, “connectivity first” means some of the security features of the multi-cloud mesh 102 is based on the connections selected by each tenant. For example, tenant A 108A can choose to connect VPC 1 110A and VPC 3 110C, but nothing else. In this example, the NMS 124 may distribute the routes for connecting VPC 1 110A and VPC 3 110C and may ensure that traffic sent/received by VPC 1 110A is to/from VPC 3 110C and vice versa. In some examples, the NMS 124 may distribute stateless firewalls to edge device(s) within the multi-cloud mesh 102, such that the techniques may not need to provide a central service all the time.

In this way, the system may provide a simplified way to manage multi-cloud connectivity between CSPs (Azure, AWS, Oracle, etc.). For instance, the system creates a new, multi-tenanted, decentralized architecture that utilizes vPoPs that are deployed within VPCs or VNETs of different CSPs, which provides the system with improved latency characteristics, and enables the system to leverage specific functionalities of each CSP when forming connections, routing traffic, etc., resulting in optimized traffic flow and reduced costs to the customer. By utilizing vPoPs that are lightweight and can be located anywhere, the system provides a way to form a new connection by setting up a new vPop in a new region within minutes, reducing latency for the customer and streamlining connection management. Further, by including lightweight security built into the vPoPs (e.g., such as ACLs, stateless actions), with hand offs of heavier features (e.g., such as deep packet inspection), the system can provide secure connections that leverage functionalities within each CSP. Accordingly, the system may automatically generate connections between a customer network and the MCN, thereby reducing complexity, infrastructure, and cost to the customer. Moreover, the system automatically handles routing (optimized for the customer based on various factors), firewalling, etc. without the customer needing to provide input (e.g., without the customer even providing an IP address), thereby streamlining connection management and reducing the number of communications between the system and the customer or API, thereby improving bandwidth and freeing up other network resources available within the MCN.

FIG. 2 illustrates a system-architecture diagram of an environment in which system 200 illustrates exemplary traffic pathways enabled by the system described in FIG. 1 herein. As illustrated, the system 200 may include cloud provider A 104A, cloud provider B 104B, region 1 106A, region 2 106B, VPC 1 110A, VPC 2 110B, VPC 3 110C, VNET(s) 112, vPoP(s) 118, and internet 122. Additionally, the system 200 may include data center 202, SASE/SSE 204, site(s) 206, and user device(s) 208.

Data center 202 may represent a physical location, such as a co-located data center, a head end, and/or any other data center associated with a service provider (e.g., such as cisco). In some examples, the data center 202 may be associated with a tenant, such as Tenant A 108A. Site(s) 206 may correspond to a branch or datacenter, such as an on-premises location of Tenant A 108A. User device(s) 208 may correspond to any computing device (e.g., computer, tablet, cell phone, laptop, etc.) configured to enable a network administrator or other user of Tenant A 108A to connect to the multi-cloud mesh. SASE/SSE 204 may represent services (e.g., secure access services edge (SASE) and security service edge (SSE) associated with security features associated with accessing a cloud (e.g., such as SD-WAN or other connections). Further, as noted above, the vPoP(s) may be integrated and/or included as part of CNHE(s) that are configured to run multi-tenanted in a cloud as a service that is managed by a service provider (e.g., Cisco). While the examples described herein relate to utilizing CNHEs, it is understood that any appropriate container may be used for the vPoPs. Accordingly, the VPC/VNET(s) within the multi-cloud mesh 102 described herein are not limited to CNHE implementations.

As illustrated, the techniques described herein enable various traffic pathways. For instance, “1” represents VPC to VPC traffic, where the vPoP(s) 118 are configured to monitor the traffic and provide simplicity, observability, security, and improved connectivity between a single region of a cloud provider. At “2”, traffic is sent between regions of a single cloud provider. In this example, the vPoP(s) 118 may be configured to add cross region encryption to the traffic, thereby providing lightweight security. “3”, illustrates that traffic may be sent cloud to cloud. In this example, the system may add cross cloud connectivity between vPoP(s). “4” illustrates that traffic may be sent cloud to internet. In this example, the vPoP(s) 118 may be configured to provide ingress and/or egress security, and may be configured to perform NAT. In some examples, pathways 1-4 are performed within the multi-cloud mesh 102, such that they do not apply to the hardware of the edge device(s).

“5” illustrates site to cloud pathway. In particular, pathway 5 illustrates the ability to utilize the vPoP(s) to enable a site 206 to automatically hook into a service provider’s SD-WAN (e.g., such as Cisco SD-WAN). For instance, the site 206 may utilize Meraki AutoVPN, catalyst SD-WAN, or any other suitable protocol to enable site-to-cloud connectivity. “6” illustrates traffic sent from the site(s) 206 through the cloud. In this example, the site may utilize a SASE to connect to the multi-cloud mesh 102. “7” illustrates a device through cloud traffic pathway. In this example, the user device(s) 208 may utilize SSE to connect to the multi-cloud mesh 102. Accordingly, the multi-cloud mesh 102 may utilize vPoP(s) 118 to enable various types of connections and traffic flows for tenants, thereby simplifying connectivity between different CSPs and enabling tenants to run their workloads in their cloud of choice with minimal setup or management of the connections. Thus, the vPoP(s) and the multi-cloud mesh 102 may ensure that IP addresses between VPCs/VNETs do not overlap or conflict and may provide lightweight security features. Thus, the techniques may provide a per-customer topology between vPoP(s) that is automated and provides flexibility in the type(s) and number of tunnels utilized, and may provide balancing across tunnels on behalf of the tenant.

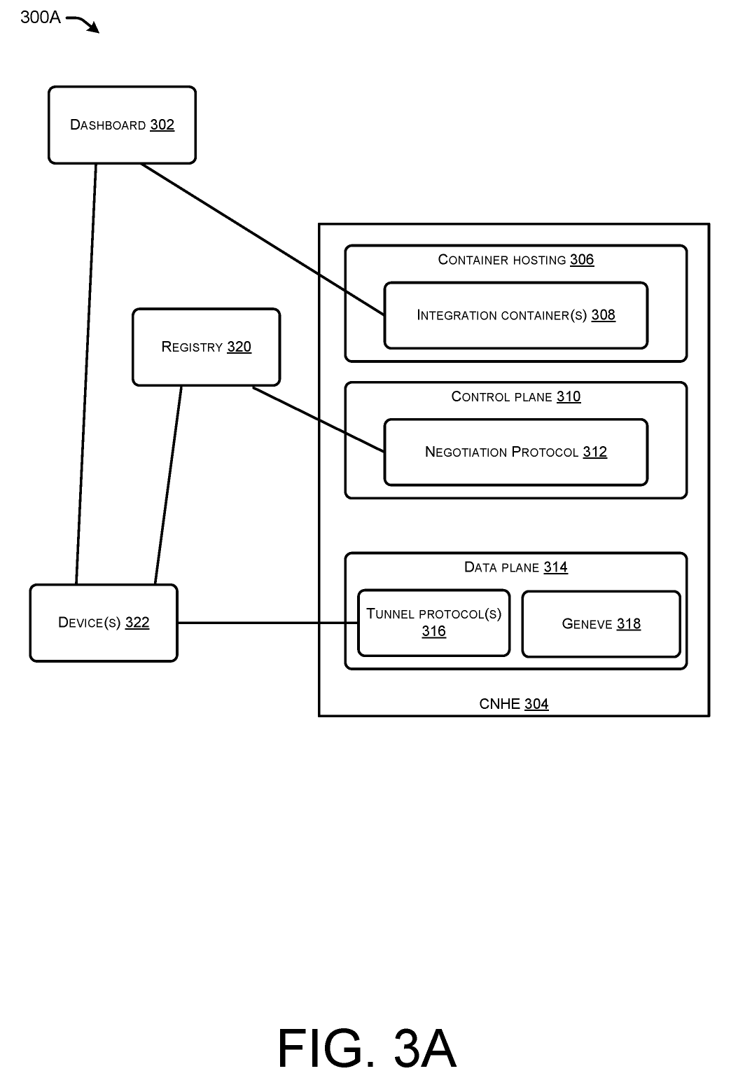

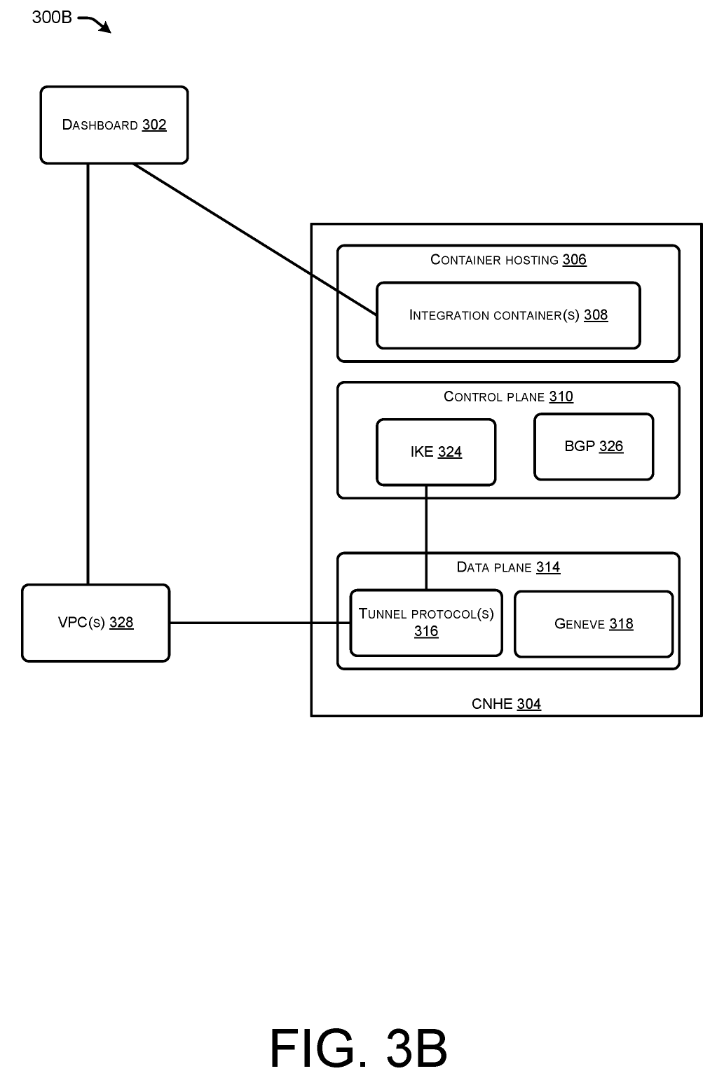

FIG. 3A illustrates an example environment 300A that supports deep integration according to the techniques described herein. In some examples, the environment 300A may correspond to an example of deep integration with Meraki. While the examples described herein relate to utilizing CNHEs, it is understood that any appropriate container may be used for the vPoPs. Accordingly, the VPC/VNET(s) within the multi-cloud mesh 102 described herein are not limited to CNHE implementations. As illustrated, the environment 300A may include a dashboard 302. In some examples, the dashboard 302 may correspond to a Meraki dashboard that enables a user (e.g., a network administrator, etc.) to access the multi-cloud mesh and/or other functionalities. In some examples, the dashboard 302 may be integrated as part of the NMS 124. The dashboard 302 may be connected to integration container(s) 308 of a CNHE 304. The CNHE 304 may be configured to support deep integrations. The integration container(s) 308 may be included as part of a container hosting 306 (e.g., such as Kubernetes container hosting or any other suitable platform). The integration container(s) 308 may comprise logic that programs the CNHE 304 to integrate and connect with the dashboard 302. In some examples, the integration container(s) may comprise container(s) built from the same Meraki code that is deployed in device(s) 322. Thus, the container(s) may appear as Meraki devices in the dashboard 302. For instance, the integration container 308 may correspond to a Meraki integration container or other suitable logic.

The CNHE 304 may comprise a containerized control plane 310. The control plane 310 may include negotiation protocol 312. For instance, with regard to the Meraki deep integration, the negotiation protocol 312 may correspond to Meraki’s Punch (e.g., AutoVPN). The negotiation protocol 312 may enable the CNHE 304 to connect to and/or integrate registry 320 (e.g., such as a Meraki registry).

The CNHE 304 may comprise a data plane 314. In some examples, the data plane 314 is pluggable. For instance, the data plane 314 may comprise tunnel protocol(s) 316 (e.g., encrypted tunnel protocol(s)). In some examples, the tunnel protocol(s) 316 may include Meraki’s AutoVPN protocol to enable the CNHE 304 to form tunnel(s) with device(s) 322 and/or other CNHEs. The data plane 314 may utilize Geneve 318 (e.g., a network encapsulation protocol), or any other suitable protocol. It is understood that the CNHE 304 may include additional or fewer elements than those illustrated.

Accordingly, by utilizing the CNHE 304, the system may be configured to build lightweight containers to integrate and deploy in CSPs, overlay management protocols (OMP), application centric infrastructure (ACI) networks, etc.

FIG. 3B illustrates an example environment 300B of the system that supports deep integration according to the techniques described herein. In some examples, environment 300B may correspond to an example of deep integration with AWS or other cloud services. In some examples, the illustrated CNHE 304 may be configured to support dynamic and on-demand (e.g., static) generation of cloud infrastructure template(s) and vPoP(s) according to the techniques described herein. While the examples described herein relate to utilizing CNHEs, it is understood that any appropriate container may be used for the vPoPs. Accordingly, the VPC/VNET(s) within the multi-cloud mesh 102 described herein are not limited to CNHE implementations.

As illustrated, the environment 300B may include dashboard 302, CNHE 304, container hosting 306, integration container(s) 308, control plane 310, data plane 314, tunnel protocol(s) 316, and Geneve 318.

As noted above, the dashboard 302 may correspond to a Meraki dashboard that enables a user (e.g., a network administrator, etc.) to access the multi-cloud mesh and/or other functionalities. In some examples, the dashboard 302 may be integrated as part of the NMS 124. In the illustrated environment 300B, the integration container(s) 308 may correspond to AWS container(s). In some examples, the control plane 310 may include IKE 324 (e.g., internet key exchange) and BGP 326 (border gateway protocol) that the CNHE 304 may use to connect to VPCs. In some examples, the container hosting 306 may include container(s) that add, within the control plane, per-tenant AWS container(s) for AWS-specific requirements. The dashboard 302 may utilize the per-tenant AWS container(s) and AWS specific requirements to configure the CNHE 304 for integration in AWS and gain statistics and state data that the NMS may use to generate cloud infrastructure templates and configure an AWS account of a customer. In some examples, the dashboard 302 may configure the CNHE 304 to include an expected AWS endpoint IP addresses, such that the CNHE 304 may provide automatic, tight DOS protection via the CNHE’s front-end ACLs.

The tunnel protocol(s) 316 in the containerized data plane 314 may comprise AWS related protocol(s). For instance, the tunnel protocol(s) 316 may correspond to IPsec or any other suitable encrypted tunneling protocol. The CNHE 304 may utilize the control plane 310 protocols and the tunneling protocol(s) to connect to VPC(s) 328. In some examples, the VPC(s) 328 comprise AWS VPC(s). In some examples, the VPC(s) 328 may correspond to tenant VPC(s) within AWS. It is understood that the CNHE 304 may include additional or fewer elements than those illustrated.

Accordingly, by utilizing the CNHE 304, the system may be configured to build lightweight containers for AWS, Azure, and GCP workflows.

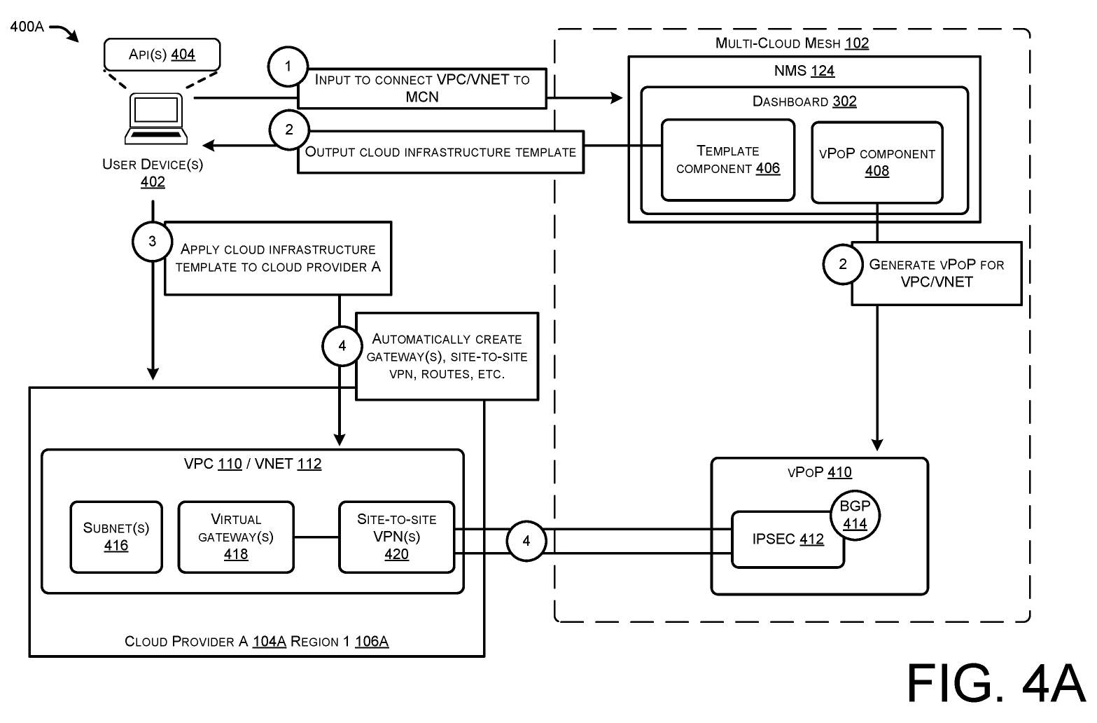

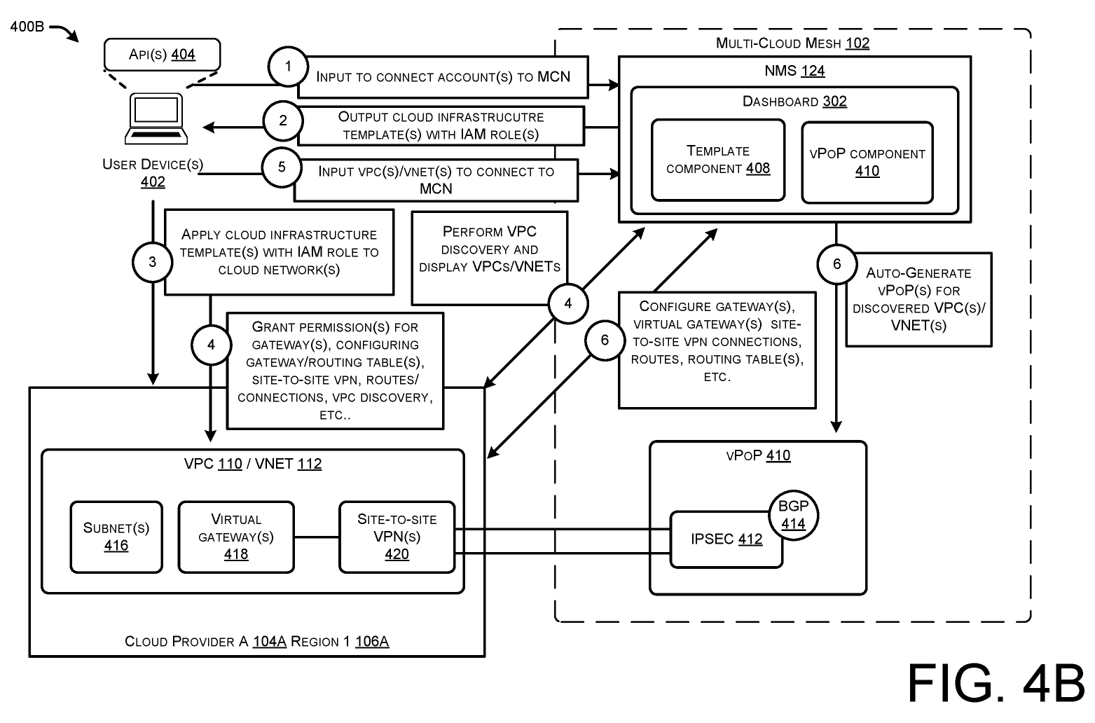

FIG. 4A illustrates a flow diagram of an example system 400A that performs on-demand generation and configuration of connections using cloud infrastructure templates and vPoPs, according to the techniques described in FIGS. 1-3B. In some instances, one or more of the steps of system 400A may be performed by one or more devices (e.g., NMS 124, etc.) that include one or more processors and one or more non-transitory computer-readable media storing computer-executable instructions that, when executed by the one or more processors, cause the one or more processors to perform operations of system 400A.

The system 400A includes user device(s) 402, which may comprise a laptop, tablet, or any other computing device of a user (e.g., such as a network administrator of a tenant). The user device(s) 402 may include one or more API(s) 404 that are configured to interface with application(s). For instance, the one or more API(s) 404 may be configured to provide output to a user interface on the user device(s) 402. The system may include the multi-cloud mesh 102, which include(s) the NMS 124. The system may also include VPC(s) 110 or VNET(s) 112 of a customer (e.g., the tenant of user device(s) 402) that are running within region 1 106A of cloud provider A 104A. While not illustrated, it is understood that vPoP(s) 118 may be included as part of a CNHE (e.g., a CNHE 304, such as CNHE VPC/VNET(s)of FIG. 1) or deployed in another container, as described herein.

The dashboard 302 may comprise a template component 406 and a vPoP component 408. The template component 406 may be configured to generate cloud infrastructure templates according to the techniques described herein. The vPoP component may be configured to generate vPoP(s) 118 (such as vPoP 410) according to the techniques described herein.

At “1”, the NMS 124 may receive input to connect a VPC or a VNET to the MCN (e.g., multi-cloud mesh 102). The input may be received from the user device(s) 402, such as through an application or dashboard and/or from an API. In this example, NMS may determine, based on the input, to statically generate the vPoPs. In some examples, the on-demand generation may occur based on the input requesting a specific VPC or VNET be connected to the multi-cloud mesh, such that the NMS infers the user intent.

At “2”, the template component 406 of the dashboard 302 may generate a cloud infrastructure template for the VPC or VNET included in the input. The NMS 124 may provide the cloud infrastructure template as output to the user device(s) 402 (e.g., such as via the API(s) and/or application that enables the user to access the dashboard). In some examples, the template component 406 may be configured to generate cloud infrastructure templates for each VPC or VNET in environments including AWS Cloud Formation, Azure Resource Group Templates, GCP, Terraform, etc. The cloud infrastructure templates may be configured to, when applied to a cloud network, automatically create virtual gateways 418, customer gateways, site-to-site VPN(s) 420, routes, etc. on the customer (e.g., tenant) side for the particular VPC or VNET, to enable the particular VPC 110 or VNET 112 to connect to the vPoP 410.

The vPoP component 408 may, in parallel, generate a vPoP 410 associated with the VPC or VNET (or each respective VPC or VNET) and deploy the vPoP 410 within the multi-cloud mesh 102. For instance, as described herein the vPoP 410 may be included as part of a VPC that a service provider of the NMS (e.g., Cisco) runs in cloud provider A 104A region 1 106A. In the illustrated system 400A, the vPoP 410 comprises protocol(s) (IPsec 412 and BGP 414) configured to form connection(s) with a VPC of the user in cloud provider A 104A region 1 106A.

At “3”, the user may apply the cloud infrastructure template(s) to a cloud account of a CSP. For instance, the user may apply the cloud infrastructure template(s) to a particular tenant account associated with VPC(s) 110/VNET(s) 112 of the user that are hosted by cloud provider A 104A.

At “4”, the cloud infrastructure templates may automatically create and set up gateway(s) (e.g., virtual gateway(s) 418, customer gateways, etc.), site-to-site VPN(s) 420, route(s), etc. within the VPC(s) 110 / VNET(s) to enable the VPC(s) 110 / VNET(s) of the customer to connect with the vPoP 410 in the multi-cloud mesh 102. As illustrated the VPC 110 / VNET 112 may include subnet(s) 416. In some examples, one or more of the subnet(s) 416 may be configured to connect to the vPoP 410.

Accordingly, on-demand generation may enable a customer to maintain control of their cloud network via an API, while still utilizing the NMS to automatically set up all the connections within the cloud network using cloud infrastructure templates. Further, where the customer wishes to change or add a new VPC/VNET, a new cloud infrastructure template can be generated for each change or addition. In this way, the system may the system may provide a streamlined and simplified way to control routing in an SD-WAN overlay, while providing the user complete control over their cloud network.

FIG. 4B illustrates a flow diagram of an example system 400B that performs dynamic generation and configuration of connections using vPoPs, according to the techniques described in FIGS. 1-4A. In some instances, one or more of the steps of system 400B may be performed by one or more devices (e.g., NMS 124, etc.) that include one or more processors and one or more non-transitory computer-readable media storing computer-executable instructions that, when executed by the one or more processors, cause the one or more processors to perform operations of system 400B.

The system 400B may include user device(s) 402, API(s) 404, multi-cloud mesh 102, NMS 124, dashboard 302, template component 406, vPoP component 408, vPoP 410, IPsec 412, BGP 414, cloud provider A 104A in region 1 106A, VPC 110/VNET 112, subnet(s) 416, virtual gateway(s) 418, and site-to-site VPN(s) 420.

At “1”, the NMS 124 may receive input to connect one or more account(s) of the user/customer to the MCN (e.g., multi-cloud mesh 102). The input may be received from the user device(s) 402, such as through an application or dashboard and/or from an API. For instance, the NMS may determine to perform dynamic generation based on the input to connection the account(s). In some examples, the account(s) may comprise one or more tenant account(s) associated with one or more CSP(s). For instance, the account(s) may be associated with tenant A 108A and/or cloud provider A, cloud provider B, etc.

At “2”, the template component 406 of the dashboard 302 may generate cloud infrastructure template(s) that are configured to add an IAM role for each of the account(s). For instance, the cloud infrastructure templates may comprise infrastructure as code and may be cloud specific. For instance, the cloud infrastructure templates may include AWS cloud formation templates, Azure Resource Manager Templates, Google Cloud Deployment Manager, etc., The IAM role may be configured to enable the NMS to perform one or more of VPC discovery, creation of virtual gateway(s), site-to-site VPN(s), customer gateway(s), etc. within each CSP.

At “3”, the user may apply the cloud infrastructure template(s) and create the IAM role(s) to one or more cloud account(s) of one or more CSP(s). For instance, the user may apply the cloud infrastructure template(s) to an account (e.g., Tenant A 108A) of cloud provider A 104A. In some examples, the cloud infrastructure template(s) may enable the user to manipulate the IAM role and change the permissions the NMS 124 has to access cloud provider A. For instance, in some examples, the user may configure the IAM role, such that the NMS 124 may perform VPC discovery but is not permitted to auto-configure the connections for the VPCs found.

At “4”, application of the cloud infrastructure templates may grant permission(s) to the NMS 124 for discovering and creating gateway(s), gateway table(s), site-to-site VPN(s), route(s), perform VPC discover, etc. In some examples, the permission(s) may include read and write permissions within the tenant A account associated with cloud provider A 104A.

In some examples, the NMS 124 may, in response to the cloud infrastructure template(s) being applied, perform VPC discovery. The NMS 124 may output the VPCs (and/or VNETs) for display to the user (e.g., such as via the dashboard 302) to enable the user to via all VPC or VNETs running within one or more CSPs.

At “5”, the NMS may receive input selecting one or more of the VPC(s) and/or VNET(s) to connect to the multi-cloud mesh 102. In some examples, the input may simply indicate the user wishes “all” of the VPCs or VNETs be connected. In some examples, the input may indicate a subset of the VPCs.

At “6”, the NMS 124 may configure, in response to the input, connections between each VPC and the multi-cloud mesh 102. For instance, the NMS 124 may access the tenant A account within cloud provider A and configure the virtual gateway(s), customer gateway(s), site-to-site VPN(s), etc. The NMS 124 additionally may set up the routing tables for each of the VPC(s) 110 and VNET(s) 112. The vPoP component 408 may, in parallel, automatically generate vPoP(s) to enable the connection to the multi-cloud mesh. For instance, the vPoP component 408 may generate a first vPoP for a portion of the VPCs running in region 1 106A of cloud provider A 104A and a second vPoP for a portion of the VPCs running in region 2 106B of cloud provider A 104A.

The NMS 124 may be configured to maintain and monitor the connections between the VPCs/VNETs of the customer and the multi-cloud mesh 102 over time. For instance, the NMS 124 may be configured to maintain routing tables on behalf of the customer, such that the system may set up traffic between the VPC 110/ VNET 112 and the vPoP 410.

In some examples, the NMS 124 may optimize the connection to minimize costs to the customer. For instance, the NMS 124 may be configured to manage traffic on behalf of the customer, such that the NMS 124 can route the traffic to minimize costs between availability zones of CSPs. For instance, routing data within an availability zone (e.g., a building or a complex of buildings or data centers of the CSPs), the customer may not incur additional costs for data movement. However, if the traffic moves between availability zones (e.g., is routed between buildings or datacenters within the same region, region-to-region, cloud-to-cloud, etc.), the customer incurs addition costs since the network resources (e.g., bandwidth, load, etc.) to move the traffic increases. Accordingly, the NMS 124 may optimize traffic to stay in the lowest cost availability zone on behalf of the customer, thereby reducing costs to the customer, while lowering the amount of network resources used, thereby improving functioning of the CSP network.

In some examples, the NMS 124 may utilize an observer component or artificial intelligence/machine learning (not illustrated) to monitor the cloud account(s) of the user. For instance, the NMS 124 may monitor the traffic flow within the cloud account(s) and through the multi-cloud mesh 102. Based on the traffic flow, the system may identify network elements (e.g., applications, VPCs, VNETs, subnets, etc.) within a cloud account of a CSP or between cloud accounts of different CSPs that the user may want to or need to connect. For instance, the NMS 124 may determine network elements to connect based on one or more of potential savings to the user (e.g., based on availability zones, reducing network resource usage, etc.), destinations of the traffic, elements the cloud accounts are accessing, bandwidth requirements, quality of service, or any other suitable metric. The system may generate and provide recommendations to the user identifying the recommended network elements.

Accordingly, dynamic generation may provide the customer a streamlined and simplified way to control and manage connections between CSPs. For instance, since the NMS may discover the network elements (e.g., VPCs, VNETs, etc.), set up the connections between the network elements and the multi-cloud mesh, and monitor and manage the connections, the customer can connect workloads between CSPs with minimal input and without requiring additional network resources, specialized networking teams, etc.

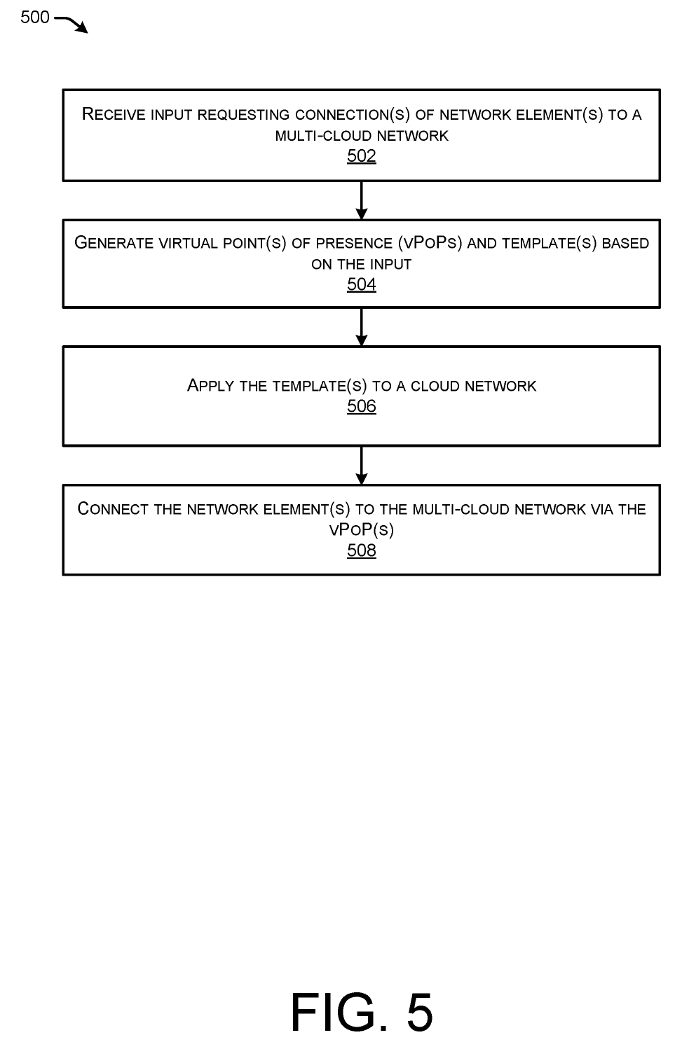

FIG. 5 illustrates a flow diagram of an example system 500 for streamlining and simplifying management of connections across CSPs using on-demand generation and configuration of connections to the MCN, according to the systems and techniques described in FIGS. 1-4B. In some instances, one or more of the steps of system 500 may be performed by one or more devices (e.g., the NMS 124, user device(s) 402, etc.) that include one or more processors and one or more non-transitory computer-readable media storing computer-executable instructions that, when executed by the one or more processors, cause the one or more processors to perform operations of system 500.

At 502, the system may receive input requesting connection(s) of network element(s) to a multi-cloud network. For instance, the system may receive input from a user device, an API, etc. The input may identify one or more network elements (e.g., VPCs, VNETs, subnet(s), etc.) the user wishes to connect to the MCN (e.g., multi-cloud mesh 102). In some examples, the input is received via dashboard 302 described herein.

At 504, the system may generate virtual point(s) of presence (vPoPs) and template(s) based on the input. For instance, the template(s) may comprise cloud infrastructure template(s). The template(s) may be generated for each of the network element(s) identified by the input. The system may provide the cloud infrastructure template as an output to the user device(s) (e.g., such as via the API(s) and/or application that enables the user to access the dashboard 302). In some examples, the template(s) may be generated by template component 406, which may be configured to generate cloud infrastructure templates that are cloud specific to a CSP of the cloud account. For instance, the template component 406 may be configured to generate cloud infrastructure templates in environments including AWS Cloud Formation, Azure Resource Group Templates, GCP, Terraform, etc. The cloud infrastructure templates may be configured to, when applied to a cloud network, automatically create virtual gateways, customer gateways, site-to-site VPN(s), traffic routes, etc. on the customer (e.g., tenant) side for the particular network element within a cloud account of a CSP, to enable the particular network element to connect to the MCN.

The system may, in parallel, generate a vPoP (e.g., such as by using vPoP component 408) to deploy within the MCN. The vPoP may be configured to connect to one or more network elements, and may be deployed as part of a VPC that a service provider of the NMS (e.g., Cisco) runs in a CSP. In some examples, the vPoP may comprise protocol(s) configured to form connection(s) with the network elements.

At 506, the system may apply the template(s) to a cloud network. For instance, the user may, via the user device, apply the cloud infrastructure template(s) to a cloud account of the cloud network (e.g., a CSP). As noted above, application of the template(s) may automatically configure and set up the connections to the MCN within the cloud account of the user and/or within the network elements.

At 508, the system may connect the network element(s) to the multi-cloud network via the vPoP(s). For instance, the network elements may connect to the vPoPs using one or more secure tunneling protocols (e.g., such as IPsec, BGP, site-to-site VPN, or any other suitable protocol).

In this way, the system may streamline and simplify management of connections across CSPs by utilizing on demand generation and application of cloud infrastructure template(s) and vPoPs to automatically configure connections between network elements and the MCN, while enabling a customer to maintain control of their cloud network via an API. Further, where the customer wishes to change or add a new VPC/VNET, a new cloud infrastructure template can be generated for each change or addition. In this way, the system may the system may provide a streamlined and simplified way to control routing in an SD-WAN overlay, while providing the user complete control over their cloud network.

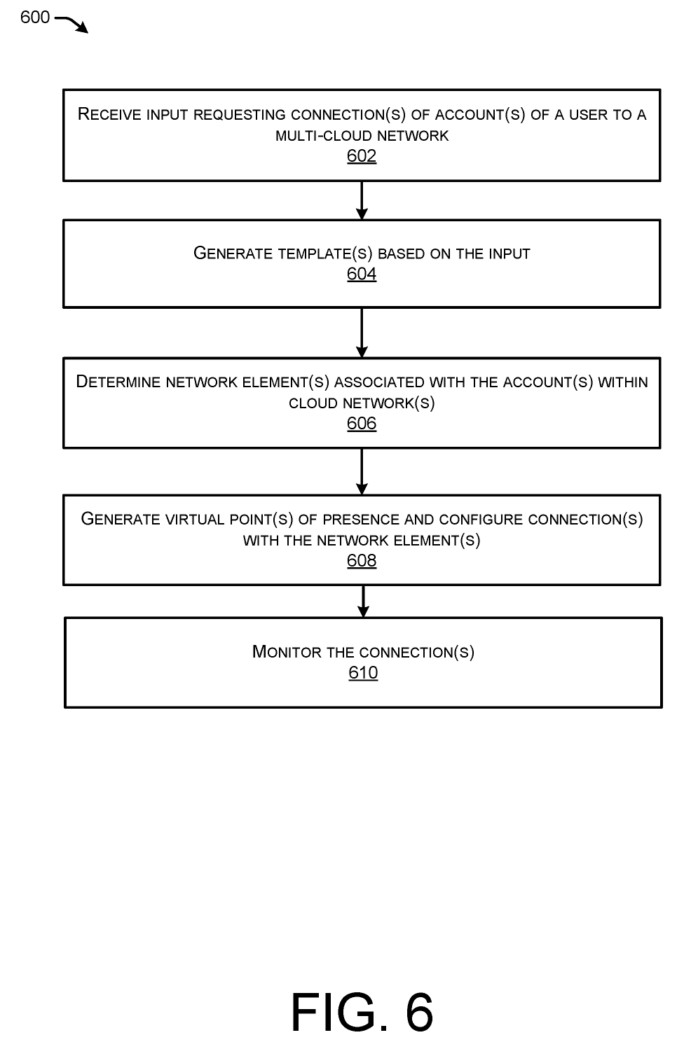

FIG. 6 illustrates a flow diagram of an example system 600 for streamlining and simplifying management of connections across CSPs based on dynamic generation and configuration of connections to the MCN, according to the systems and techniques described in FIGS. 1-5. In some instances, one or more of the steps of system 600 may be performed by one or more devices (e.g., NMS 124, user device(s) 402, etc.) that include one or more processors and one or more non-transitory computer-readable media storing computer-executable instructions that, when executed by the one or more processors, cause the one or more processors to perform operations of system 500.

At 602, the system may receive input requesting connection(s) of account(s) of a user to a multi-cloud network. For instance, the input may be received from a user device of a network administrator, such as through an application or API that enables the network administrator to access a dashboard within the network management system. In some examples, the account(s) may comprise one or more cloud account(s) associated with one or more CSPs.

At 604, the system may generate template(s) based on the input. For instance, the templates may comprise cloud infrastructure templates.

In some examples, the cloud infrastructure template includes instructions to add an IAM role for the NMS to the cloud account of the user. The IAM role may enable the NMS to: perform discovery of the network elements; configure, within the cloud network and for each of the network elements, one or more gateways including virtual gateways, user gateways, site-to-site virtual private networks; create the connections between each of the network elements and the vPoPs, the connections including traffic routing; and configure and maintain routing tables for each of the network elements within the cloud network.

In some examples, the IAM role is configurable by the user to restrict or increase access and trust permissions of the NMS. For instance, the user may configure the IAM role to grant full access and trust to the NMS (e.g., enable dynamic configuration and monitoring) or partial access and trust (e.g., enable semi-static configuration and monitoring, such as by enabling VPC discovery but not configuration of gateways and connections).

At 606, the system may determine network element(s) associated with the account(s) within cloud network(s). In some examples, the network elements comprise one or more virtual private clouds, virtual networks, SD-WAN connection, or other cloud connection. In some examples, determining the network element(s) may comprise automatically discovering, by the NMS and based on performing VPC discovery, one or more virtual private clouds (VPCs) within the cloud account; receiving input requesting the one or more VPCs be connected to the MCN; configuring connections for each of the one or more VPCs within the cloud account; and creating routes between each of the one or more VPCs and the MCN by connecting the one or more VPCs to at least one vPoP in the MCN.

In some examples, the input requests that a subset of the one or more VPCs be connected to the MCN, wherein the NMS configures the connections for each VPC in the subset of the one or more VPCs and creates the routes between the subset of the one or more VPCs and the MCN.

At 608, the system may generate virtual point(s) of presence and configure connection(s) with the network element(s). As noted above, the one or more vPoPs may comprise cloud native head end (CNHE) vPoPs. The vPoPs may be multi-tenanted and may be configured to perform lightweight security function(s), while handing off heavier weight functions (e.g., such as deep packet inspection). In some examples, the vPoPs are configured to perform NAT or other lightweight functions.

In some examples, generating the one or more vPoPs may comprise generating, by the NMS, one or more vPoP configurations for the cloud network to instantiate and instantiating, by the NMS and within the MCN, the one or more vPoPs.

At 610, the system may monitor the connection(s). For instance, the system may monitor the connection(s), perform optimized traffic routing, maintain routing tables, perform upgrades, handle security ticket, etc. on behalf of the user.

In some examples, the system may be configured to hook in additional security services. For instance, the system may be configured to identify traffic for a particular route (e.g., such as traffic from a particular VPC of the user to the Internet). In this example, the user may provide input to the dashboard indicating a preference for additional security to be applied to the identified or selected traffic flow. The user may also select a security service (e.g., deep packet inspection, firewall services, etc.) for the NMS to offload the traffic flow too.

In this way, the system may provide a simplified way to manage multi-cloud connectivity between CSPs (Azure, AWS, Oracle, etc.). For instance, the system creates a new, decentralized architecture that utilizes vPoPs that are deployed within VPCs or VNETs of different CSPs, which provides the system with improved latency characteristics, and enables the system to leverage specific functionalities of each CSP when forming connections, routing traffic, etc., resulting in optimized traffic flow and reduced costs to the customer. By utilizing vPoPs that are lightweight and can be located anywhere, the system provides a way to form a new connection by setting up a new vPop in a new region within minutes, reducing latency for the customer and streamlining connection management. Further, by including lightweight security built into the vPoPs (e.g., such as ACLs, stateless actions), with hand offs of heavier features (e.g., such as deep packet inspection), the system can provide secure connections that leverage functionalities within each CSP. Accordingly, the system may automatically generate connections between a customer network and the MCN, thereby reducing complexity, infrastructure, and cost to the customer. Moreover, the system automatically handles routing (optimized for the customer based on various factors), firewalling, etc. without the customer needing to provide input (e.g., without the customer even providing an IP address), thereby streamlining connection management and reducing the number of communications between the system and the customer or API, thereby improving bandwidth and freeing up other network resources available within the MCN.

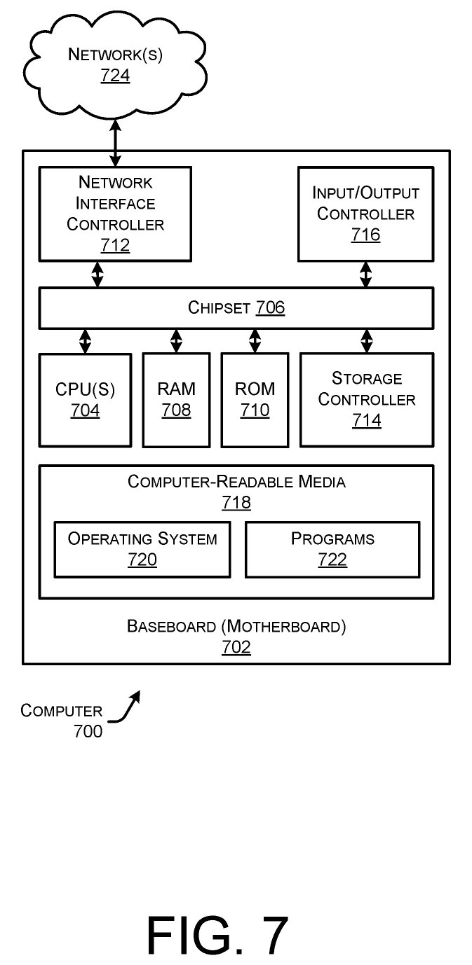

FIG. 7 shows an example computer architecture for a device capable of executing program components for implementing the functionality described above. The computer architecture shown in FIG. 7 illustrates any type of computer 700, such as a conventional server computer, workstation, desktop computer, laptop, tablet, network appliance, e-reader, smartphone, or other computing device, and can be utilized to execute any of the software components presented herein. The computer may, in some examples, correspond to a NMS 124, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs 704”) operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 700. The chipset 706 can further provide an interface to a computer-readable storage medium such as a read-only memory (“ROM”) 710 or non-volatile RAM (“NVRAM”) for storing basic routines that help to startup the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as network(s) 724. The network(s) 724 may correspond to internet 122, the multi-cloud mesh 102, etc. The chipset 706 can include functionality for providing network connectivity through a NIC 712, such as a gigabit Ethernet adapter. The NIC 712 is capable of connecting the computer 700 to other computing devices over the network(s) 724. It should be appreciated that multiple NICs 712 can be present in the computer 700, connecting the computer to other types of networks and remote computer systems.

The computer 700 can be connected to a storage device 718 that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 718 by detecting the physical states or characteristics of one or more particular locations within the physical storage units.

In addition to the mass storage device 718 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by the NMS 124, and/or any components included therein, may be supported by one or more devices similar to computer 700. Stated otherwise, some or all of the operations performed by the NMS 124, and/or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

As described herein, the computer 700 may comprise one or more of a NMS 124, and/or any other device. The computer 700 may include one or more hardware processors (processor(s), such as CPUs 704) configured to execute one or more stored instructions. The processor(s) may comprise one or more cores. Further, the computer 700 may include one or more network interfaces configured to provide communications between the computer 700 and other devices, such as the communications described herein as being performed by the NMS 124, and/or any other device. The network interfaces may include devices configured to couple to personal area networks (PANs), wired and wireless local area networks (LANs), wired and wireless wide area networks (WANs), SDWANs, and so forth. For example, the network interfaces may include devices compatible with Ethernet, Wi-Fi™, and so forth.

The programs 722 may comprise any type of programs or processes to perform the techniques described in this disclosure. For instance, the programs 722 may cause the computer 700 to perform techniques including receiving, by the NMS, input to connect a cloud account of a user to the MCN; generating, by the NMS and based on the input, a cloud infrastructure template; determining, by the NMS and based on the cloud infrastructure template being applied to the cloud account in a cloud network, network elements within the cloud network; determining, by the NMS, one or more network elements to connect to the MCN; generating, by the NMS, one or more virtual points of presence (vPoPs) within the MCN configured to form connections to the one or more network elements; and monitoring, by the NMS, the connections.

In this way, the computer 700 may may provide a simplified way to manage multi-cloud connectivity between CSPs (Azure, AWS, Oracle, etc.). For instance, the system creates a new, decentralized architecture that utilizes vPoPs that are deployed within VPCs or VNETs of different CSPs, which provides the system with improved latency characteristics, and enables the system to leverage specific functionalities of each CSP when forming connections, routing traffic, etc., resulting in optimized traffic flow and reduced costs to the customer. By utilizing vPoPs that are lightweight and can be located anywhere, the system provides a way to form a new connection by setting up a new vPop in a new region within minutes, reducing latency for the customer and streamlining connection management. Further, by including lightweight security built into the vPoPs (e.g., such as ACLs, stateless actions), with hand offs of heavier features (e.g., such as deep packet inspection), the system can provide secure connections that leverage functionalities within each CSP. Accordingly, the system may automatically generate connections between a customer network and the MCN, thereby reducing complexity, infrastructure, and cost to the customer. Moreover, the system automatically handles routing (optimized for the customer based on various factors), firewalling, etc. without the customer needing to provide input (e.g., without the customer even providing an IP address), thereby streamlining connection management and reducing the number of communications between the system and the customer or API, thereby improving bandwidth and freeing up other network resources available within the MCN.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method of providing a network management system (NMS) as service of a multi-cloud network (MCN), the method comprising:
receiving, by the NMS, input to connect a cloud account of a user to the MCN;
generating, by the NMS and based on the input, a cloud infrastructure template;
determining, by the NMS and based on the cloud infrastructure template being applied to the cloud account in a cloud network, network elements within the cloud network;
determining, by the NMS, one or more network elements to connect to the MCN;
generating, by the NMS, one or more virtual points of presence (vPoPs) within the MCN configured to form connections to the one or more network elements; and
monitoring, by the NMS, the connections.

2. The method of claim 1, wherein generating the one or more vPoPs further comprises:
generating, by the NMS, one or more vPoP configurations for the cloud network to instantiate; and
instantiating, by the NMS and within the MCN, the one or more vPoPs.

3. The method of claim 1, wherein the cloud infrastructure template includes instructions to add an IAM role for the NMS to the cloud account of the user, the IAM role enabling the NMS to:
perform discovery of the network elements;
configure, within the cloud network and for each of the network elements, one or more gateways including virtual gateways, user gateways, site-to-site virtual private networks;
create the connections between each of the network elements and the vPoPs, the connections including traffic routing; and
configure and maintain routing tables for each of the network elements within the cloud network.

4. The method of claim 3, wherein the IAM role is configurable by the user to restrict or increase access and trust permissions of the NMS.

5. The method of claim 1, wherein the network elements comprise one or more virtual private clouds, virtual networks, SD-WAN connection, or other cloud connection.

6. The method of claim 1, wherein the network elements comprise VPCs and determining the network elements further comprises:
automatically discovering, by the NMS and based on performing VPC discovery, one or more virtual private clouds (VPCs) within the cloud account;
receiving input requesting the one or more VPCs be connected to the MCN;
configuring the connections for each of the one or more VPCs within the cloud account; and
creating routes between each of the one or more VPCs and the MCN by connecting the one or more VPCs to at least one vPoP in the MCN.

7. The method of claim 6, wherein the input requests that a subset of the one or more VPCs be connected to the MCN, wherein the NMS configures the connections for each VPC in the subset of the one or more VPCs and creates the routes between the subset of the one or more VPCs and the MCN.

8. The method of claim 1, wherein the cloud infrastructure templates comprise infrastructure as code and are specific to a cloud service provider of the cloud account.

9. The method of claim 1, wherein the one or more vPoPs are multi-tenanted.

10. The method of claim 1, wherein the one or more vPoPs are configured to perform a lightweight security function.

11. A system, comprising:
one or more processors; and
one or more computer-readable media storing instructions that, when executed by the one or more processors, cause the one or more processors to perform operations comprising:
receiving, by a network management system (NMS), input to connect a cloud account of a user to a multi-cloud network (MCN);
generating, by the NMS and based on the input, a cloud infrastructure template;
determining, by the NMS and based on the cloud infrastructure template being applied to the cloud account in a cloud network, network elements within the cloud network;
determining, by the NMS, one or more network elements to connect to the MCN;
generating, by the NMS, one or more virtual points of presence (vPoPs) within the MCN configured to form connections to the one or more network elements; and
monitoring, by the NMS, the connections.

12. The system of claim 11, wherein generating the one or more vPoPs further comprises:
generating, by the NMS, one or more vPoP configurations for the cloud network to instantiate; and
instantiating, by the NMS and within the MCN, the one or more vPoPs.

13. The system of claim 11, wherein the cloud infrastructure template includes instructions to add an IAM role for the NMS to the cloud account of the user, the IAM role enabling the NMS to:
perform discovery of the network elements;
configure, within the cloud network and for each of the network elements, one or more gateways including virtual gateways, user gateways, site-to-site virtual private networks;
create the connections between each of the network elements and the vPoPs, the connections including traffic routing; and
configure and maintain routing tables for each of the network elements within the cloud network.

14. The system of claim 13, wherein the IAM role is configurable by the user to restrict or increase access and trust permissions of the NMS.

15. The system of claim 11, wherein determining the network elements further comprises:
automatically discovering, by the NMS and based on performing VPC discovery, one or more virtual private clouds (VPCs) within the cloud account;
receiving input requesting the one or more VPCs be connected to the MCN;
configuring the connections for each of the one or more VPCs within the cloud account; and
creating routes between each of the one or more VPCs and the MCN by connecting the one or more VPCs to at least one vPoP in the MCN.

16. The system of claim 15, wherein the input requests that a subset of the one or more VPCs be connected to the MCN, wherein the NMS configures the connections for each VPC in the subset of the one or more VPCs and creates the routes between the subset of the one or more VPCs and the MCN.

17. The system of claim 11, wherein the one or more vPoPs are multi-tenanted or configured to perform a lightweight security function.

18. One or more non-transitory computer-readable media maintaining instructions that, when executed by one or more processors of a network management system (NMS), program the one or more processors to perform operations comprising:
receiving input to connect a cloud account of a user to a multi-cloud network (MCN);
generating, based on the input, a cloud infrastructure template;
determining, based on the cloud infrastructure template being applied to the cloud account in a cloud network, network elements within the cloud network;
determining a network element of the network elements to connect to the MCN;
generating a virtual point of presence (vPoP) configured to form a connection to the network element; and
monitoring the connection.

19. The one or more non-transitory computer-readable media of claim 18, wherein the cloud infrastructure template includes instructions to add an IAM role for the NMS to the cloud account of the user, the IAM role enabling the one or more processors to:
perform discovery of the network element;
configure, within the cloud network and for each of the network elements, one or more gateways including virtual gateways, user gateways, site-to-site virtual private networks;
create the connections between each of the network elements and the vPoPs, the connections including traffic routing; and
configure and maintain routing tables for each of the network elements within the cloud network.

20. The one or more non-transitory computer-readable media of claim 18, wherein the network elements comprise one or more virtual private clouds, virtual networks, SD-WAN connections, or other cloud connections.
